(19) United States
(12) Patent Application Publication
(10) Pub. No.: US 2011/0231234 A1
(43) Pub. Date: Sep. 22, 2011

(54) EFFECTIVE ATTENTION DISPOSING SYSTEM

(76) Inventor: David Phillip Gobel, Springfield, VA (US)

(21) Appl. No.: 12/728,473

(22) Filed: Mar. 22, 2010

(51) Int. Cl. G06Q 30/00; G06Q 10/00; G06Q 20/00

(52) U.S. Cl. 705/14.13; 705/14.19; 705/14.25

(57) ABSTRACT

Methods and electronic device system for effective disposing attentions among large number of attention seekers. A server system that registers attention seekers' requests, votes and/or monetary bids, ranks the requests according the statistics of the received votes or bids and personal interest of the attention giver. The requests of the higher ranks are selected for attention of the attention giver.

### BACKGROUND OF THE INVENTION

1. Field of the Invention

The present application relates to an electronic system that ranks levels of attentions in a communication, more particularly, relates to an electronic system that achieves Pareto efficiency in attention targeting in a large communicative environment or community.

Note that the points discussed below may reflect the hindsight gained from the disclosed inventions, and are not necessarily admitted to be prior art.

2. Description of Related Art

The main activity of humans is communication. In order to communicate, one must secure the attention of the target(s) of the communication prior to communication. There are often significant hurdles, including social, political, geophysical and topological to mention a few to achieving attention. For instance, in a conference, the speaker will typically ask if there are any questions following a presentation. In the case of a large audience and many questions, there is no way the speaker can address all questions, nor is there an efficient way to rank order the questions on various criteria such as relevance, comprehensibility or broader value to an audience vs. the questioner's personal value. This situation is common in topoligies where the conversational transaction is “one to many”, or more colloquially, “broadcast”.

Further, there are myriad situations where communication is scarce, even though it could be done face to face (one to one). For example, one might wish to directly communicate with the President, or with Stephen Spielberg. Since individuals such as these have enormous demands on their time, they must expend significant effort to prevent the expenditure of their time on communication that is deemed by their administrative and security apparatus to be of low value and thus below the threshold where they would allow the communication to occur.

A more general example would be the costs corporations incur in order to maintain purchasing departments whose key goal is to mediate the impacts of myriad salespersons trying to make a sale. There are serious social and dollar costs involved in maintaining the very expensive administrative and security apparatus, to maximize the time of the key individual(s), or in other words, to maximize the scarcity value of their time. In a more efficient world, it would be valuable to reduce the cost and complexity of the filtering apparatus while allowing additional high value(d) communication to flow, thus maximizing the outcomes for both the communicator and receiver.

One current methodology for securing attention is advertising. Advertising is an indirect method whereby a communicator (seller/supplicant) makes an offer/pitch by buying the attention of an audience from “attention aggregators” such as magazines, TV, radio, newspapers, social media, Google Adwords and etc. In this case, the communication is very indirect, and both the communicator and the target pay a third party (the aggregator).

Devices and methods for rating audience questions and/or responses is known in the prior art. More specifically, by way of example, U.S. Pat. No. 6,760,595 to Inselberg discloses a method for providing interactive audience participation at live spectator events. Participating spectators employ wireless interactive devices that present a promotional message and include user input and output interfaces. Spectators are queried, and enter answers via the user input interface. The answers are transmitted to a central processor, stored as spectator data, and processed into results. A visual display or the user output interface announces the results to the spectators.

U.S. Pat. No. 5,860,023 to Tognazzini discloses a polling and communications device which permits a speaker to interact with an audience in data or voice modes. Questions can be transmitted to the speaker in data form. Alternatively, the speaker can selectively activate a wireless microphone for a particular member of the audience in response to an indication, sent over a data channel that a user has a question. Alternatively, a user can record a voice message and store it in memory for transmission over a data link. Information about a questioner is provided to the speaker from information stored during registration for the event and may also be provided to the audience.

U.S. Pat. No. 5,537,141 to Harper, et al. discloses an interactive distance learning system which provides individualized interactive responses to each student, as if the student is receiving instruction directly from a private tutor. An interactive program transmission occurs to a diverse number of facilities and locations. The primary transmission is a live lecture by the person making the presentation on the distance learning system. The live lecture is accompanied by questions to gage comprehension by students. The questions, in interrogatory form, are graphically displayed on the screen either as video or overlaying the video showing the lecturer. In addition to the interrogatory question, a set of responses, one correct, the rest incorrect, are also presented for the student choice.

U.S. Pat. No. 5,273,437 to Caldwell, et al. discloses an audience participation system and method utilizing wireless transmission. The system includes a plurality of modules in the possession of an audience, each module having a keypad or other means which is activated by a member of the audience in order for the audience to respond to a question posed by the speaker during his presentation. After the speaker poses a question, the audience responds by supplying information through a physical input into the module. The module then encodes the information provided into an encoded electrical pattern. This encoded electrical pattern is modulated into an electromagnetic signal which is then electromagnetically transmitted. A base station has a receiver for capturing the electromagnetic signal which is then demodulated into the encoded electrical pattern originally transmitted. The data are retrieved and collected, and then statistically analyzed according to the wishes of the speaker and displayed to present a statistical analysis of the combined audience response to the question posed.

U.S. Pat. No. 5,036,389 to Morales discloses a satellite controlled TV audience response system which provides means for current processing of answers to audience polls so that answers may be presented in TV pictures alongside the questions substantially instantaneously. The system has the capacity to process both local audience responses such as those in the vicinity of a particular TV station, and audiences over a large geographic area, so that responses can be analyzed to take into account regional differences in response or differences in the listeners to different TV station audiences. Responses can be analyzed at local ground stations for billing purposes, etc., and can be analyzed at the satellite station for retransmission of various audience responses to the polled audience.

### SUMMARY OF THE INVENTION

The present application discloses new approaches to efficiently targeting valued attentions in a massive “one to many” communication environment. Many economic system seeks to achieve Pareto efficiency, where when given a set of choices, if one individual can change one input that will make at least one individual better off without making any other individual worse off a “Pareto improvement” has occurred.

An electronic direct communication facilitative system is designed to achieve Pareto efficiency in attention targeting. This electronic system achieves this means to the most efficiency level possible by allowing all members of a subset to participate in the overall outcome of the group.

In a scenario where questions are formulated by the whole audience and voted upon therein, the resulting outcome will have optimal benefit upon the entire subset itself.

In one aspect of an embodiment, the system includes a function that accepts/requests for communication to a target.

In another aspect of an embodiment, the system includes a function that sets a monetary or other transaction with a value competent as an offer to the target(s).

In another aspect of an embodiment, the system includes a function that allows third parties to rate/rank/improve the value of the proposed communication.

In another aspect of an embodiment, the system includes a function that allows others to share in the outcome of successful communications by bidding on or buying a share in the outcome.

In another aspect of an embodiment, the system includes a function that allows any/all of the a) attention aggregator/agent b) communication initiator c) target to allocate value (dollar) proceeds of the successful communication.

In another aspect of an embodiment, the system includes a function that automates the collection, issuing of rights, distribution of value (money) and product (the communication).

The system allows a communicator to directly communicate with all members of his audience at the same time, and enable a communicator to achieve Pareto efficiency in situation of massive broadcast style communications.

The more important features of the invention have thus been outlined in order that the more detailed description that follows may be better understood and in order that the present contribution to the art may better be appreciated. Additional features of the invention will be described hereinafter and will form the subject matter of the claims that follow.

Many aspects and features of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 schematically shows an example of the functional modules of the system in accordance with the principles of the invention;

FIGS. 2, 3, 4, 5 schematically show an example functional module for each party of interest during a communication in accordance with this application respectively; and

FIG. 6 schematically shows an example functional server module of the system in accordance with this application.

### DETAILED DESCRIPTION OF SAMPLE EMBODIMENTS

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The disclosed system can effectively dis-intermediate the role of an attention aggregator to a significant degree in the value chain of accessing the target of a given communication effort.

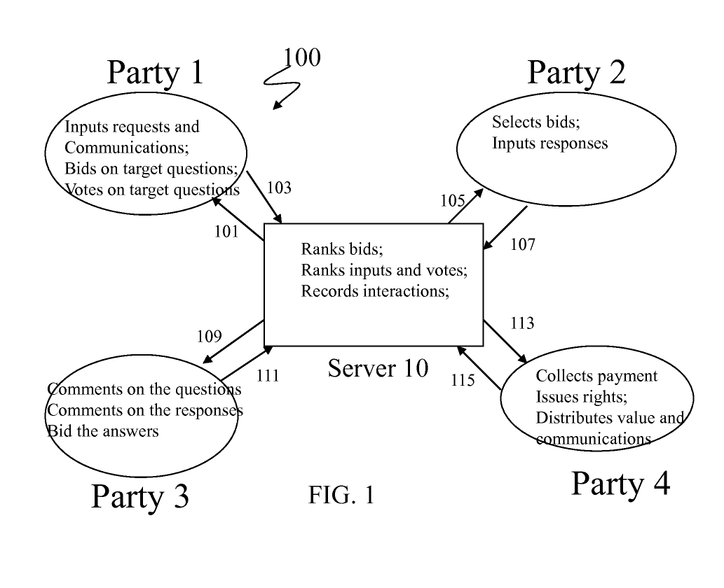

In reference to FIG. 1, an example scenario is: during a large conference such as the TED conference, there are thousands of attendees (Party 1), and there are world class presenters (Party 2), all taking place during a limited time where there is limited time for questions. This scenario presents the case of (1) scarce time and (2) high value presenters and (3) perhaps high value audience members who will be of follow-up-interest in their own right. There are also people (Party 3) who are not included in the conference, and the organizers of the conference (Party 4).

At the end of a presentation, a member of the audience would normally line up to get a microphone and hope that they are close enough to the microphone that they will not end up being last in line (and thus have no hope of getting to ask their question). In the case of this application, the questioners (Party 1) would instead log on to the LongTailOfAttention system 100 through the functional module for Party 1 and register their questions and vote on others' questions. Party 1's choices are electronically (step 103) sent to a server system 10 via internet or wireless networks.

The server 10 would collect and store the questions, calculate the ranks according to the number of votes, and post the questions during the speaker's talk by electronically sending the results to Party 2 via internet or wireless networks (step 105). All questions submitted to server system 10 would be arranged based on voting rank by other participants of Party 1 (whether physically or virtually present). Votes may also be weighted if the participant is of special importance.

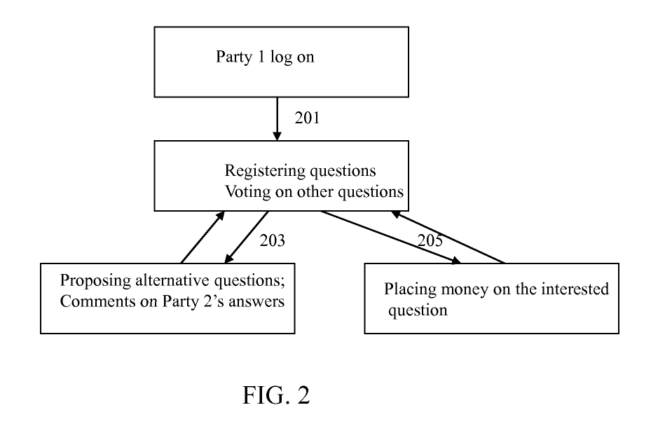

In reference to FIG. 2, these participants of Party 1 log on to the system at their user interface/module, and vote on their agreement or (disagreement) as to a question's absolute and relative value and importance at step 201. Additionally, all participants in the system would be able to comment on the question, debate its value and propose modifications at step 203, alternatives and improvements to the question. In this scenario, the wisdom of informed crowds will select the questions that are of greatest interest to the largest audience, dis-intermediating a moderator who may have an alternate agenda or preventing “silly” questions.

Additionally, if a questioner really wants his question answered, at step 205, he has the option to make a monetary offer through the system to essentially buy votes that can put their question in/at the top of the queue, or alternatively, to offer the system and key participants a monetary incentive to answer the question (or engage in a communication) at a later time with a deadline commitment.

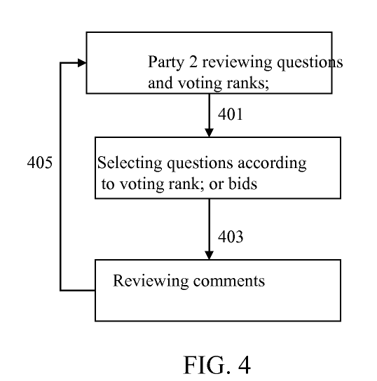

In reference to FIG. 4, the speaker or presenter (Party 2) views the ranked questions or comments (step 403, 405), selects the most valued question to answer or comment (step 401).

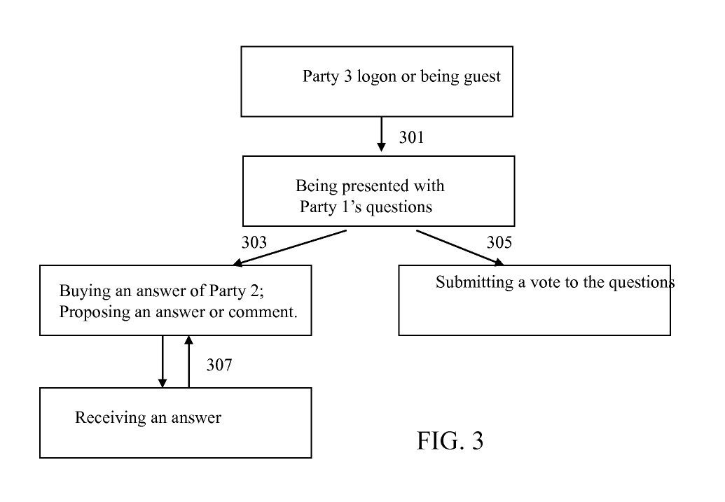

In reference to FIG. 3, the contents of the questions may be posted on a module designed for the public or other third parties (step 301) via internet or wireless network. In the case of a question that has great perceived merit, the questioner, target and aggregator can post the questions and sell the paid for answers to other parties via step 303 and 307. Party 3 may also post their comments and votes to the system (step 305).

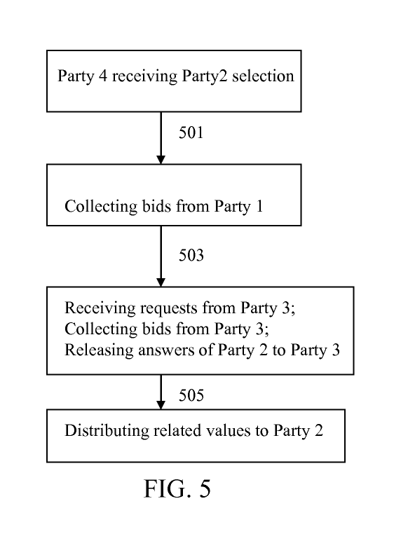

In reference to FIG. 5, the organizers, agents (Party 4) can logon to the system and use their user interface to summarize and collect the information about the parties of interest, collect and distribute the payments/bids.

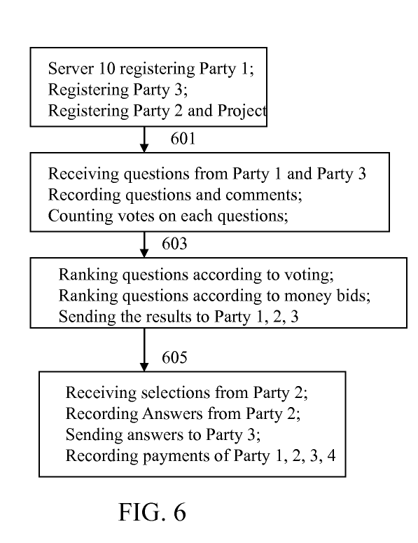

In reference to FIG. 6, server system 10 includes a database that registers and stores information about Party 1, 2, 3, and 4. After registering and storing the participants, the server 10 database also accepts and stores the questions and comments from the participants (step 601). After collecting and counting votes from the participants, the database also stores the information and the associated monetary values (step 603), and the server 10 system sends the integrated information to the logged on parties. At step 605, the server collects, stores and sends the responses from the different parties to the corresponding requesting parties.

The above system monetizes the tail-of-attention whether it be physical, broadcast, virtual, one to one, one to many or many to many. It can be used to tender a request for communication to a high value target, for example, “I will pay Stephen Spielberg $25,000 for ½ hour of his time” or “I am offering Pee Wee Herman $1,000 for a lunch” via this system. Further, a corporation could require that salespersons make a monetary offer to get a piece of a decision maker's precious time without having to brave and traverse the gauntlet of gatekeepers.

The system would also allow the target (Party 2) to rebate value to the communicator (Party 1) in the case of a very satisfactory communication.

The system database stores each participant's interactions and feedbacks, thus provides a rating system whereby encounters and interactions among the participants are rated with percentage of positiveness, such that over time people who waste other peoples time may be required to spend more and more money to get attention. The system informs the bidder and target about possible outcome about their communication. For example, for successful bidder: “I met with Mr. Spielberg, and I got great value for the money spent.” Mr Spielberg's feedback might be: “I met with the questioner and if I'd known the value of his question I would have met him for free.”

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An electronic attention disposing device system in a communication, comprising:
a device module for a plurality of attention seekers;
a device module for a target attention giver; and
a server device wherein said plurality of attention seekers and said attention giver are linked electronically, and each of said attention seekers provides an incentive to the target attention giver to respond to a request, and said target attention giver chooses to respond the request that has the highest rank of the incentives.

2. The device of claim 1, wherein said incentive is a count of vote for a request.

3. The device of claim 1, wherein said incentive is a monetary bid.

4. The device of claim 1, further comprising a device module for monitoring and crediting the incentive for the request that received response.

5. The device of claim 1, further comprising a device module for additional interested parties of later time to pay for the response to a chosen request.

6. The device of claim 1, wherein the incentives are weighted according to the attention seekers' profile or the target attention giver's personal interest.

7. An electronic attention disposing device system in a communication, comprising:
a device module for a plurality of attention seekers;
a device module for a target attention giver;
a device module for monitoring communications between said attention seeker and said attention giver by a third party; and
a server device wherein said plurality of attention seekers, said attention giver and said third party are linked electronically, and each of said attention seekers provides an incentive to the target attention giver to respond to a request, and said target attention giver chooses to respond the request that has the highest rank of the incentives for which are ranked by the third party.

8. The device of claim 7, wherein said incentive is a count of vote for a request.

9. The device of claim 7, wherein said incentive is a monetary bid.

10. The device of claim 7, further comprising a device module for monitoring and crediting the incentive for the request that received response.

11. The device of claim 7, further comprising a device module for additional interested parties of later time to pay for the response to a chosen request.

12. The device of claim 7, wherein the incentives are weighted according to the attention seekers' profile or the target attention giver's personal interest.

13. A method for effective attention disposing by an attention giver, comprising the steps of actions of:
registering of a plurality of requests of attention seekers by an electronic system;
calculating the level of interest of each of said requests based on statistics collected by the electronic system;
responding by the attention giver to the request that is of the highest interest.

14. The method of claim 13, wherein said level of interest is calculated by counting votes for a request.

15. The method of claim 13, wherein said level of interest is calculated by comparing monetary bids.

16. The method of claim 13, further comprising the actions of monitoring the process by a third party and crediting parties of interest.

17. The method of claim 13, further comprising a device module for additional interested parties of later time to pay for the response to a chosen request.

18. The method of claim 13, wherein the statistics data are weighted according to the attention seekers' profile or the target attention giver's personal interest.
